(19) United States
(12) Patent Application Publication
(10) Pub. No.: US 2018/0277145 A1
(43) Pub. Date: Sep. 27, 2018

(54) INFORMATION PROCESSING APPARATUS FOR EXECUTING EMOTION RECOGNITION

(71) Applicant: CASIO COMPUTER CO., LTD., Tokyo (JP)

(72) Inventor: Takashi YAMAYA, Tokyo (JP)

(73) Assignee: CASIO COMPUTER CO., LTD., Tokyo (JP)

(21) Appl. No.: 15/868,421

(22) Filed: Jan. 11, 2018

(30) Foreign Application Priority Data
Mar. 22, 2017 (JP) 2017-056482

(51) Int. Cl. G10L 25/63; G10L 15/02; G10L 15/06; G10L 15/22

(52) U.S. Cl. CPC G10L 25/63; G10L 15/02; G10L 2015/223; G10L 15/22; G10L 2015/025; G10L 15/063

(57) ABSTRACT

An information processing apparatus comprises a learner and a processing unit. The learner learns a phoneme sequence generated from a voice as an emotion phoneme sequence, in accordance with relevance between the phoneme sequence and an emotion of a user. The processing unit executes processing pertaining to emotion recognition in accordance with a result of learning by the learner. The information processing apparatus suppresses execution of a process that does not conform to an emotion of a user.

### CROSS-REFERENCE TO RELATED APPLICATION

This application claims the benefit of Japanese Patent Application No. 2017-056482, filed on Mar. 22, 2017, the entire disclosure of which is incorporated by reference herein.

### FIELD

This application relates to an information processing apparatus for executing emotion recognition.

### BACKGROUND

Technologies for executing a process corresponding to an emotion of a speaker using voices are known.

For example, Unexamined Japanese Patent Application Kokai Publication No. H11-119791 discloses a voice emotion recognition system that uses features of a voice to output a level indicating a degree of the speaker's emotion contained in the voice.

### SUMMARY

An information processing apparatus according to the present disclosure comprising:
a processor; and
a storage that stores a program to be executed by the processor,
wherein the processor is caused to execute by the program stored in the storage:
   a learning process that learns a phoneme sequence generated from a voice as an emotion phoneme sequence, in accordance with relevance between the phoneme sequence and an emotion of a user; and
   an emotion recognition process that executes processing pertaining to emotion recognition in accordance with a result of learning in the learning process.

### BRIEF DESCRIPTION OF THE DRAWINGS

A more complete understanding of this application can be obtained when the following detailed description is considered in conjunction with the following drawings, in which:

FIG. 1 is a diagram illustrating a physical configuration of an information processing apparatus according to Embodiment 1 of the present disclosure;

FIG. 2 is a diagram illustrating a functional configuration of the information processing apparatus according to Embodiment 1 of the present disclosure;

FIG. 3 is a diagram illustrating an example structure of frequency data;

FIG. 4 is a diagram illustrating an example structure of emotion phoneme sequence data;

FIG. 5 is a flowchart for explaining a learning process executed by the information processing apparatus according to Embodiment 1 of the present disclosure;

FIG. 6 is a flowchart for explaining an emotion recognition process executed by the information processing apparatus according to Embodiment 1 of the present disclosure;

FIG. 7 is a diagram illustrating a functional configuration of an information processing apparatus according to Embodiment 2 of the present disclosure; and

FIG. 8 is a flowchart for explaining an updating process executed by the information processing apparatus according to Embodiment 2 of the present disclosure.

### DETAILED DESCRIPTION

### Embodiment 1

An information processing apparatus according to Embodiment 1 of the present disclosure is described below with reference to the drawings. Identical reference symbols are given to identical or equivalent components throughout the drawings.

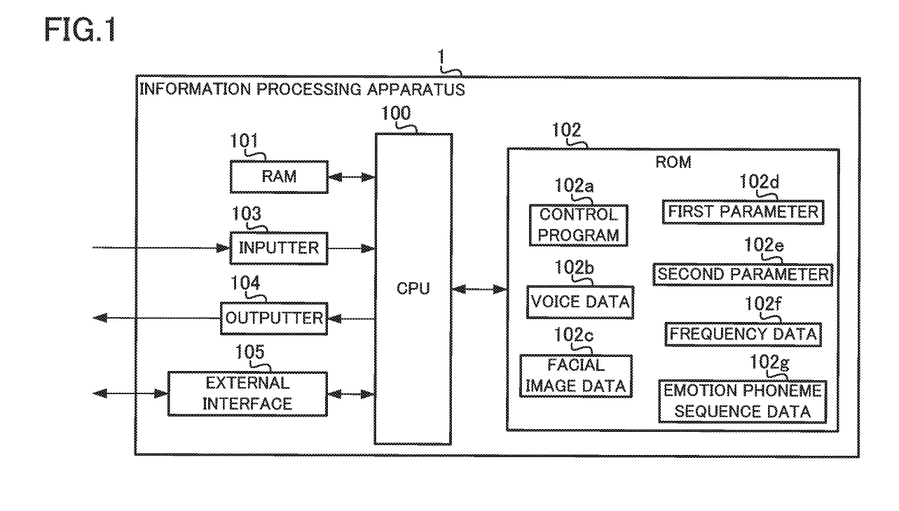

The information processing apparatus 1 illustrated in FIG. 1 is provided with a learning mode and an emotion recognition mode as operation modes. As described in detail below, by operating in accordance with the learning mode, the information processing apparatus 1 learns a phoneme sequence that is among phoneme sequences generated from a voice and has high relevance to an emotion of a user as an emotion phoneme sequence. Furthermore, by operating in accordance with the emotion recognition mode, the information processing apparatus 1 recognizes an emotion of the user in accordance with a result of learning in the learning mode, and outputs an emotion image and an emotion voice representing a result of the recognition. The emotion image is an image corresponding to an emotion of the user that has been recognized. The emotion voice is a voice corresponding to an emotion of the user that has been recognized. Hereinafter, a case is described in which the information processing apparatus 1 recognizes the user's emotion as one of three types of emotions: a positive emotion such as delight, a negative emotion such as anger or sorrow, and a neutral emotion being neither the positive emotion nor the negative emotion.

The information processing apparatus 1 comprises a central processing unit (CPU) 100, random access memory (RAM) 101, read only memory (ROM) 102, an inputter 103, an outputter 104, and an external interface 105.

The CPU 100 executes various processes including a learning process and an emotion recognition process, which are described below, in accordance with programs and data stored in the ROM 102. The CPU 100 is connected to the individual components of the information processing apparatus 1 via a system bus (not illustrated) being a transmission path for commands and data, and performs overall control of the entire the information processing apparatus 1.

The RAM 101 stores data generated or acquired by the CPU 100 by executing various processes. Furthermore, the RAM 101 functions as a work area for the CPU 100. That is, the CPU 100 executes various processes by reading out a program or data into the RAM 101 and referencing the read-out program or data as necessary.

The ROM 102 stores programs and data to be used by the CPU 100 for executing various processes. Specifically, the ROM 102 stores a control program 102a to be executed by the CPU 100. Furthermore, the ROM 102 stores a plurality of pieces of voice data 102b, a plurality of pieces of facial image data 102c, a first parameter 102d, a second parameter 102e, frequency data 102f, and emotion phoneme sequence data 102g. The first parameter 102d, the second parameter 102e, the frequency data 102f, and the emotion phoneme sequence data 102g are described below.

The voice data 102b is a data representing a voice uttered by the user. The facial image data 102c is a data representing a facial image of the user. As described below, in the learning mode, the information processing apparatus 1 learns an emotion phoneme sequence described above by using the voice data 102b and facial image data 102c. Furthermore, in the emotion recognition mode, the information processing apparatus 1 recognizes the user's emotion by using the voice data 102b and facial image data 102c. The voice data 102b is generated by an external recording apparatus by recording a voice uttered by the user. The information processing apparatus 1 acquires the voice data 102b from the recording apparatus via the external interface 105 described below and stores the voice data 102b in the ROM 102 in advance. The facial image data 102c is generated by an external imaging apparatus by imaging a facial image of the user. The information processing apparatus 1 acquires the facial image data 102c from the imaging apparatus via the external interface 105 and stores the facial image data 102c in the ROM 102 in advance.

The ROM 102 stores the voice data 102b and the facial image data 102c representing a facial image that was imaged when a voice represented by the voice data 102b was recorded in association with each other. That is, the voice data 102b and the facial image data 102c associated with each other respectively represent a voice and a facial image recorded and imaged at the same point of time, and contain information indicating an emotion of the user as of the same point of time.

The inputter 103 comprises an input apparatus such as a keyboard, a mouse, or a touch panel and the like, receives various operation instructions inputted by the user, and supplies the received operation instructions to the CPU 100. Specifically, the inputter 103 receives selection of operation mode for the information processing apparatus 1 and selection of voice data 102b, in accordance with an operation by the user.

The outputter 104 outputs various information in accordance with control by the CPU 100. Specifically, the outputter 104 comprises a displaying device such as a liquid crystal panel and the like and displays the aforementioned emotion image on the displaying device. Furthermore, the outputter 104 comprises a sounding device such as a speaker and the like and sounds the aforementioned emotion voice from the sounding device.

The external interface 105 comprises a wireless communication module and a wired communication module, and transmits and receives data to and from an external apparatus by executing wireless or wired communication between the external apparatus. Specifically, the information processing apparatus 1 acquires the aforementioned voice data 102b, facial image data 102c, first parameter 102d, and second parameter 102e from an external apparatus via the external interface 105 and stores these pieces of data in the ROM 102 in advance.

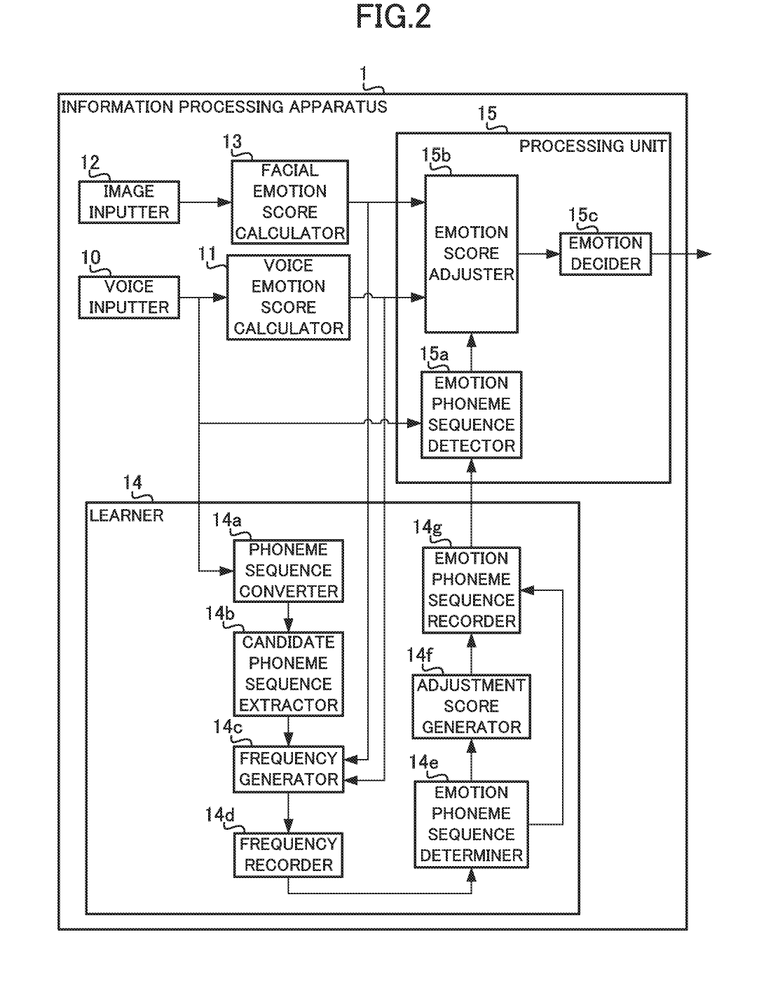

Comprising physical configuration described above, the information processing apparatus 1 comprises, as functions of the CPU 100, a voice inputter 10, a voice emotion score calculator 11, an image inputter 12, a facial emotion score calculator 13, a learner 14, and a processing unit 15, as illustrated in FIG. 2. The CPU 100 functions as these individual components by controlling the information processing apparatus 1 by executing the control program 102a.

The voice inputter 10 acquires the voice data 102b designated by the user by operating the inputter 103 from the plurality of pieces of voice data 102b stored in the ROM 102. In the learning mode, the voice inputter 10 supplies the acquired voice data 102b to the voice emotion score calculator 11 and to the learner 14. Furthermore, in the emotion recognition mode, the voice inputter 10 supplies the acquired voice data 102b to the voice emotion score calculator 11 and to the processing unit 15.

In accordance with the voice represented by the voice data 102b supplied by the voice inputter 10, the voice emotion score calculator 11 calculates a voice emotion score pertaining to each of the aforementioned three types of emotions. The voice emotion score is a numeric value indicating a level of possibility that an emotion the user felt when uttering a voice is the emotion pertaining to the voice emotion score. For example, a voice emotion score pertaining to the positive emotion indicates the level of possibility that the emotion the user felt when uttering a voice is the positive emotion. In the present embodiment, the larger a voice emotion score is, the higher a level of possibility that the user's emotion is an emotion pertaining to the voice emotion score is.

Specifically, the voice emotion score calculator 11, by functioning as a classifier in accordance with the first parameter 102d stored in the ROM 102, calculates a voice emotion score in accordance with a feature amount representing a non-linguistic feature of a voice contained in the voice data 102b, such as loudness of the voice, hoarseness of the voice, or squeakiness of the voice and the like. The first parameter 102d is generated by an external information processing apparatus by executing machine learning which uses, as a teacher data, a general-purpose data that includes feature amounts of voices uttered by a plurality of speakers and an information indicating emotions that the speakers felt when uttering those voices in association with each other. The information processing apparatus 1 acquires the first parameter 102d from the external information processing apparatus via the external interface 105 and stores the first parameter 102d in the ROM 102 in advance.

In the learning mode, the voice emotion score calculator 11 supplies the calculated voice emotion score to the learner 14. Furthermore, in the emotion recognition mode, the voice emotion score calculator 11 supplies the calculated voice emotion score to the processing unit 15.

From among the plurality of pieces of facial image data 102c stored in the ROM 102, the image inputter 12 acquires the facial image data 102c stored in association with the voice data 102b that was acquired by the voice inputter 10. The image inputter 12 supplies the acquired facial image data 102c to the facial emotion score calculator 13.

The facial emotion score calculator 13 calculates the facial emotion score pertaining to each of the aforementioned three types of emotions in accordance with the facial image represented by the facial image data 102c supplied by the image inputter 12. The facial emotion score is a numeric value indicating a level of possibility that an emotion felt by the user when the facial image was imaged is the emotion pertaining to the facial emotion score. For example, a facial emotion score pertaining to the positive emotion indicates a level of possibility that an emotion felt by the user when the facial image was imaged is the positive emotion. In the present embodiment, the larger a facial emotion score is, the higher a level of possibility that the user's emotion is the emotion pertaining to the facial emotion score is.

Specifically, the facial emotion score calculator 13, by functioning as a classifier in accordance with the second parameter 102e stored in the ROM 102, calculates a facial emotion score in accordance with a feature amount of a facial image represented by the facial image data 102c. The second parameter 102e is generated by an external information processing apparatus by executing machine learning which uses, as a teacher data, a general-purpose data in which feature amounts of facial images of a plurality of photographic subjects and an information indicating emotions that the photographic subjects felt when the facial images are imaged in association with each other. The information processing apparatus 1 acquires the second parameter 102e from the external information processing apparatus via the external interface 105 and stores the second parameter 102e in the ROM 102 in advance.

In the learning mode, the facial emotion score calculator 13 supplies the calculated facial emotion score to the learner 14. Furthermore, in the emotion recognition mode, the facial emotion score calculator 13 supplies the calculated facial emotion score to the processing unit 15.

As described above, the voice and the facial image respectively represented by the voice data 102b and the facial image data 102c associated with each other are acquired at the same point of time and express an emotion of the user as of the same point of time. Hence, a facial emotion score calculated in accordance with the facial image data 102c indicates a level of possibility that the emotion the user felt when uttering the voice represented by the voice data 102b associated with the facial image data 102c is the emotion pertaining to the facial emotion score. By using both a voice emotion score and a facial emotion score, even if the emotion that the user felt when uttering a voice is expressed by only one of the voice and the facial image, the information processing apparatus 1 can recognize the emotion and improve the accuracy of the learning.

In the learning mode, the learner 14 learns a phoneme sequence having high relevance to the user's emotion as an emotion phoneme sequence. Furthermore, the learner 14 learns an adjustment score corresponding to the relevance between an emotion and an emotion phoneme sequence in association with the emotion phoneme sequence. Specifically, the learner 14 comprises a phoneme sequence converter 14a, a candidate phoneme sequence extractor 14b, a frequency generator 14c, a frequency recorder 14d, an emotion phoneme sequence determiner 14e, an adjustment score generator 14f, and an emotion phoneme sequence recorder 14g.

The phoneme sequence converter 14a converts a voice represented by the voice data 102b supplied by the voice inputter 10 into a phoneme sequence to which part-of-speech information is added. That is, the phoneme sequence converter 14a generates a phoneme sequence from a voice. The phoneme sequence converter 14a supplies the acquired phoneme sequence to the candidate phoneme sequence extractor 14b. Specifically, the phoneme sequence converter 14a converts a voice represented by the voice data 102b into a phoneme sequence by executing voice recognition on the voice on a sentence-by-sentence basis. The phoneme sequence converter 14a conducts a morphological analysis on the voice represented by the voice data 102b to divide the phoneme sequence acquired through the aforementioned voice recognition into morphemes, and then adds part-of-speech information to each morpheme.

The candidate phoneme sequence extractor 14b extracts a phoneme sequence that satisfies a predetermined extraction condition from the phoneme sequences supplied by the phoneme sequence converter 14a as a candidate phoneme sequence which is a candidate for the emotion phoneme sequence. The extraction condition is set by using any method such as an experiment and the like. The candidate phoneme sequence extractor 14b supplies the extracted candidate phoneme sequence to the frequency generator 14c. Specifically, the candidate phoneme sequence extractor 14b extracts, as a candidate phoneme sequence, a phoneme sequence that includes three continuous morphemes and that has part-of-speech information other than proper nouns.

By extracting a phoneme sequence that includes three continuous morphemes, even when an unknown word is erroneously recognized to be divided into about three morphemes, the candidate phoneme sequence extractor 14b can capture the unknown word and extract the word as a candidate emotion phoneme sequence, thereby improving accuracy of the learning. Furthermore, by excluding proper nouns such as place names and personal names and the like, which are unlikely to express an emotion of the user, from a candidate for the emotion phoneme sequence, the candidate phoneme sequence extractor can improve accuracy of the learning and reduce a processing load.

With respect to each candidate phoneme sequence supplied by the candidate phoneme sequence extractor 14b, the frequency generator 14c determines, for each of the aforementioned three types of emotions, whether a possibility that the emotion the user felt when uttering a voice corresponding to the candidate phoneme sequence is the emotion is significantly high or not. The frequency generator 14c supplies frequency information representing a result of the determination to the frequency recorder 14d.

Specifically, with respect to each candidate phoneme sequence, for each emotion, the frequency generator 14c acquires, the voice emotion score calculated in accordance with the voice data 102b corresponding to the candidate phoneme sequence and the facial emotion score calculated in accordance with the facial image data 102c associated with the voice data 102b from the voice emotion score calculator 11 and the facial emotion score calculator 13 respectively. The frequency generator 14c determines, for each emotion, whether a possibility that the emotion the user felt when uttering a voice corresponding to the candidate phoneme sequence is the emotion is significantly high, by determining whether the acquired voice emotion score and facial emotion score satisfy a detection condition. As described above, a facial emotion score calculated in accordance with the facial image data 102c indicates a level of possibility that the emotion the user felt when uttering the voice represented by the voice data 102b associated with the facial image data 102c is the emotion pertaining to the facial emotion score.

That is, both the voice emotion score calculated in accordance with the voice data 102b corresponding to the candidate phoneme sequence and the facial emotion score calculated in accordance with the facial image data 102c associated with the voice data 102b indicate a level of possibility that the emotion the user felt when uttering the voice corresponding to the candidate phoneme sequence is the emotion pertaining to the voice emotion score and facial emotion score. The voice emotion score and the facial emotion score corresponds to an emotion score, while the frequency generator 14c corresponds to an emotion score acquirer.

More specifically, the frequency generator 14c acquires a total emotion score pertaining to each emotion by summing up the acquired voice emotion score and the acquired facial emotion score for each emotion, and determines whether the voice emotion score and the facial emotion score satisfy the detection condition by determining whether the total emotion score is equal to or greater than a detection threshold. The detection threshold is predetermined by using any method such as an experiment and the like. For example, when it is determined that the total emotion score pertaining to the positive emotion which is a total value of the voice emotion score pertaining to the positive emotion and the facial emotion score pertaining to the positive emotion calculated respectively in accordance with the voice data 102b and the facial image data 102c corresponding to a candidate phoneme sequence is equal to or greater than the detection threshold, the frequency generator 14c determines that a possibility that an emotion that the user felt when uttering a voice corresponding to the candidate phoneme sequence is the positive emotion is significantly high.

The frequency recorder 14d updates the frequency data 102f stored in the ROM 102 in accordance with the frequency information supplied by the frequency generator 14c. The frequency data 102f is a data that includes, in association with a candidate phoneme sequence, for each of the aforementioned three types of emotions, an emotion frequency pertaining to an emotion which is a cumulative value of number of times of determination by the frequency generator 14c that a possibility that the emotion the user felt when uttering a voice corresponding to the candidate phoneme sequence is the emotion is significantly high. In other words, the frequency data 102f includes, in association with a candidate phoneme sequence, for each emotion, a cumulative value of number of times of determination by the frequency generator 14c that the voice emotion score and facial emotion score pertaining to the emotion respectively calculated in accordance with the voice data 102b and the facial image data 102c corresponding to the candidate phoneme sequence satisfy the detection condition.

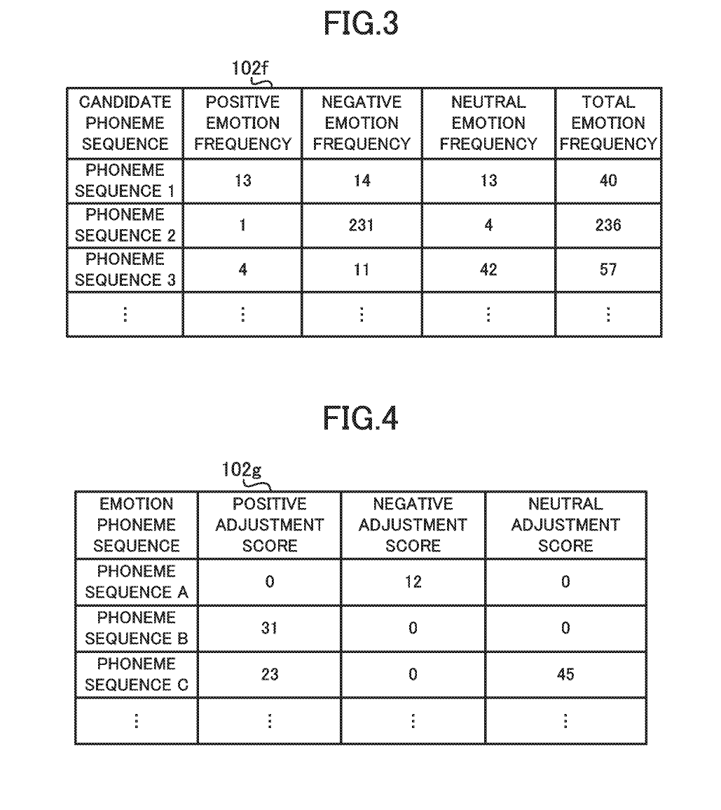

Specifically, as illustrated in FIG. 3, the frequency data 102f includes a candidate phoneme sequence, a positive emotion frequency pertaining to the positive emotion, a negative emotion frequency pertaining to the negative emotion, a neutral emotion frequency pertaining to the neutral emotion, and a total emotion frequency in association with each other. The positive emotion frequency is a cumulative value of number of times of determination by the frequency generator 14c that a possibility that the emotion the user felt when uttering a voice corresponding to the candidate phoneme sequence is the positive emotion is significantly high. In other words, the positive emotion frequency is a cumulative value of number of times of determination by the frequency generator 14c that the positive voice emotion score and the positive facial emotion score respectively calculated in accordance with the voice data 102b and the facial image data 102c corresponding to the candidate phoneme sequence satisfy the detection condition. The negative emotion frequency is a cumulative value of number of times of determination by the frequency generator 14c that a possibility that the emotion the user felt when uttering a voice corresponding to the candidate phoneme sequence is the negative emotion is significantly high. The neutral emotion frequency is a cumulative value of number of times of determination by the frequency generator 14c that a possibility that the emotion the user felt when uttering a voice corresponding to the candidate phoneme sequence is the neutral emotion is significantly high. The total emotion frequency is a total value of the positive emotion frequency, the negative emotion frequency, and the neutral emotion frequency.

Referring back to FIG. 2, when the frequency information indicating that it is determined that a possibility that the emotion the user felt when uttering a voice corresponding to a candidate phoneme sequence is an emotion is significantly high is supplied from the frequency generator 14c, the frequency recorder 14d adds 1 to the emotion frequency pertaining to the emotion included in the frequency data 102f in association with the candidate phoneme sequence. As a result, the frequency data 102f is updated. For example, when the frequency information indicating that it is determined that a possibility that the emotion the user felt when uttering a voice corresponding to a candidate phoneme sequence is the positive emotion is significantly high is supplied, the frequency recorder 14d adds 1 to the positive emotion frequency included in the frequency data 102f in association with the candidate phoneme sequence.

The emotion phoneme sequence determiner 14e acquires the frequency data 102f stored in the ROM 102, and determines whether a candidate phoneme sequence is an emotion phoneme sequence by evaluating, for each emotion, the relevance between the candidate phoneme sequence and the emotion in accordance with the acquired frequency data 102f. The emotion phoneme sequence determiner 14e corresponds to a frequency data acquirer and a determiner. The emotion phoneme sequence determiner 14e supplies a data indicating a result of the determination to the emotion phoneme sequence recorder 14g. Furthermore, the emotion phoneme sequence determiner 14e supplies information indicating a relevance between an emotion phoneme sequence and an emotion to the adjustment score generator 14f.

Specifically, the emotion phoneme sequence determiner 14e determines, from among candidate phoneme sequences, that a candidate phoneme sequence is an emotion phoneme sequence if the relevance between the candidate phoneme sequence and any one of the aforementioned three types of emotions is significantly high, and an emotion frequency ratio, which is a ratio of the emotion frequency pertaining to the emotion and being included in the frequency data 102f in association with the candidate phoneme sequence to the total emotion frequency included in the frequency data 102f in association with the candidate phoneme sequence, is equal to or greater than a learning threshold. The learning threshold is set by using any method such as an experiment and the like.

The emotion phoneme sequence determiner 14e determines whether a relevance between a candidate phoneme sequence and an emotion is significantly high by testing a null hypothesis that “the relevance between the emotion and the candidate phoneme sequence is not significantly high; in other words, the emotion frequency pertaining to the emotion is equal to the emotion frequencies pertaining to the other two emotions” using the chi-square test. Specifically, the emotion phoneme sequence determiner 14e acquires a value calculated by dividing the total emotion frequency which is a total value of emotion frequencies pertaining to each emotion by 3 which is the number of emotions as an expected value. The emotion phoneme sequence determiner 14e calculates a chi-square value in accordance with the expected value and with the emotion frequency pertaining to the emotion, which is the determination target, being included in the frequency data 102f in association with the candidate phoneme sequence, which is the determination target. The emotion phoneme sequence determiner 14e tests the calculated chi-square value with a chi-square distribution having two, which is a number calculated by subtracting one from three which is the number of emotions, as degrees of freedom, which is obtained by subtracting 1 from the number of emotion types, three. When a probability of the chi-square is less than a significance level, the emotion phoneme sequence determiner 14e determines that the aforementioned null hypothesis is rejected, and determines that the relevance between the candidate phoneme sequence and the emotion, both of which are determination targets, is significantly high. The significance level is predetermined by using any method such as an experiment and the like.

The emotion phoneme sequence determiner 14e supplies the probability of chi-square used for the aforementioned determination of significance along with the aforementioned emotion frequency ratio, as information indicating the aforementioned relevance, to the adjustment score generator 14f. The larger an emotion frequency ratio is, the higher a relevance between an emotion phoneme sequence and an emotion is. Furthermore, the smaller a probability of chi-square is, the higher a relevance between an emotion phoneme sequence and an emotion is.

With respect to each emotion phoneme sequence, the adjustment score generator 14f generates, for each emotion, an adjustment score pertaining to the emotion which is a numeric value corresponding to the relevance between the emotion phoneme sequence and the emotion. The adjustment score generator 14f supplies the generated adjustment score to the emotion phoneme sequence recorder 14g. Specifically, the higher the relevance between the emotion phoneme sequence and the emotion indicated by the information supplied by the emotion phoneme sequence determiner 14d is, the larger a value set as the adjustment score by the adjustment score generator 14f is. As described below, the processing unit 15 recognizes the user's emotion in accordance with the adjustment score. The larger a value of an adjustment score is, the more likely the emotion pertaining to the adjustment score is decided as the user's emotion. That is, the adjustment score generator 14f, by setting a larger value as the adjustment score corresponding to higher relevance between an emotion phoneme sequence and an emotion, makes it more likely that the emotion having higher relevance to the emotion phoneme sequence is decided as the user's emotion. More specifically, the adjustment score generator 14f sets a larger value as the adjustment score for a higher emotion frequency ratio that is supplied as the information indicating the relevance, while setting a larger value as the adjustment score for a lower probability of chi-square that is also supplied as the information indicating the relevance.

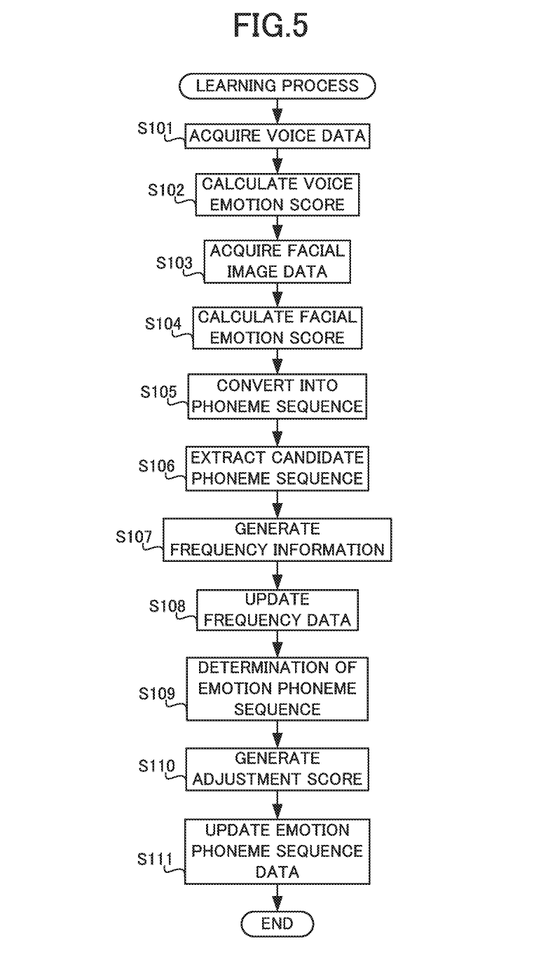

The emotion phoneme sequence recorder 14g updates the emotion phoneme sequence data 102g stored in the ROM 102 in accordance with a result of determination of an emotion phoneme sequence supplied by the emotion phoneme sequence determiner 14e and with the adjustment score supplied by the adjustment score generator 14f. The emotion phoneme sequence data 102g is a data that includes an emotion phoneme sequence and adjustment scores pertaining to each emotion generated in accordance with the emotion phoneme sequence in association with each other. Specifically, as illustrated in FIG. 4, the emotion phoneme sequence data 102g includes an emotion phoneme sequence, a positive adjustment score, a negative adjustment score, and a neutral adjustment score in association with each other. The positive adjustment score is an adjustment score pertaining to the positive emotion. The negative adjustment score is an adjustment score pertaining to the negative emotion. The neutral adjustment score is an adjustment score pertaining to the neutral emotion.

Referring back to FIG. 2, in response to the determination by the emotion phoneme sequence determiner 14e that a candidate phoneme sequence that is not stored yet in the emotion phoneme sequence data 102g as an emotion phoneme sequence is an emotion phoneme sequence, the emotion phoneme sequence recorder 14g stores the emotion phoneme sequence in association with the adjustment scores supplied by the adjustment score generator 14f. Furthermore, in response to the determination by the emotion phoneme sequence determiner 14e that a candidate phoneme sequence that is already stored in the emotion phoneme sequence data 102g as an emotion phoneme sequence is an emotion phoneme sequence, the emotion phoneme sequence recorder 14g updates the adjustment score stored in association with the emotion phoneme sequence by replacing the adjustment score with an adjustment score supplied by the adjustment score generator 14f. Furthermore, in response to the determination by the emotion phoneme sequence determiner 14e that a candidate phoneme sequence that is already stored in the emotion phoneme sequence data 102g as an emotion phoneme sequence is not an emotion phoneme sequence, the emotion phoneme sequence recorder 14g deletes the emotion phoneme sequence from the emotion phoneme sequence data 102g. That is, when a candidate phoneme sequence that is once determined to be an emotion phoneme sequence by the emotion phoneme sequence determiner 14e and is stored in the emotion phoneme sequence data 102g is determined not to be an emotion phoneme sequence by the emotion phoneme sequence determiner 14e in the subsequent learning process, the emotion phoneme sequence recorder 14g deletes the candidate phoneme sequence from the emotion phoneme sequence data 102g. As a result, a storage load is reduced while accuracy of the learning is improved.

In the emotion recognition mode, the processing unit 15 recognizes the user's emotion in accordance with a result of learning by the learner 14, and outputs the emotion image and the emotion voice that represent a result of the recognition. Specifically, the processing unit 15 comprises an emotion phoneme sequence detector 15a, an emotion score adjuster 15b, and an emotion decider 15c.

In response to supplying of voice data 102b by the voice inputter 10, the emotion phoneme sequence detector 15a determines whether any emotion phoneme sequence is included in a voice represented by the voice data 102b. The emotion phoneme sequence detector 15a supplies a result of the determination to the emotion score adjuster 15b. Furthermore, when determining that the voice includes an emotion phoneme sequence, the emotion phoneme sequence detector 15a acquires adjustment scores pertaining to each emotion stored in the emotion phoneme sequence data 102g in association with the emotion phoneme sequence, and supplies the acquired adjustment scores along with the result of determination to the emotion score adjuster 15b.

Specifically, the emotion phoneme sequence detector 15a generates an acoustic feature amount from the emotion phoneme sequence and determines whether any emotion phoneme sequence is included in the voice represented by the voice data 102b by comparing the acoustic feature amount with an acoustic feature amount generated from the voice data 102b. Note that, whether any emotion phoneme sequence is included in the voice may be determined by converting the voice represented by the voice data 102 into a phoneme sequence by performing voice recognition on the voice, and comparing the phoneme sequence with an emotion phoneme sequence. In the present embodiment, by determining whether there is any emotion phoneme sequence through comparison using acoustic feature amounts, lowering of accuracy of determination due to erroneous recognition in voice recognition is suppressed and accuracy of emotion recognition is improved.

The emotion score adjuster 15b acquires a total emotion score pertaining to each emotion in accordance with the voice emotion score supplied by the voice emotion score calculator 11, the facial emotion score supplied by the facial emotion score calculator 13, and the result of determination supplied by the emotion phoneme sequence detector 15a. The emotion score adjuster 15b supplies the acquired total emotion score to the emotion decider 15c.

Specifically, in response to the determination by the emotion phoneme sequence detector 15a that an emotion phoneme sequence is included in the voice represented by the voice data 102b, the emotion score adjuster 15b acquires, with respect to each emotion, a total emotion score pertaining to the emotion by summing up the voice emotion score, the facial emotion score, and the adjustment score supplied by the emotion phoneme sequence detector 15a. For example, the emotion score adjuster 15b acquires a total emotion score pertaining to the positive emotion by summing up the voice emotion score pertaining to the positive emotion, the facial emotion score pertaining to the positive emotion, and a positive adjustment score. Furthermore, in response to the determination by the emotion phoneme sequence detector 15a that no emotion phoneme sequence is included in the voice, the emotion score adjuster 15b acquires, with respect to each emotion, a total emotion score pertaining to the emotion by summing up the voice emotion score and the facial emotion score.

The emotion decider 15c decides which one of the aforementioned three types of emotions the user's emotion is, in accordance with the total emotion scores pertaining to each emotion supplied by the emotion score adjuster 15b. The emotion decider 15c generates an emotion image or an emotion voice representing the decided emotion, supplies the emotion image or the emotion voice to the outputter 104, and causes the outputter 104 to output the emotion image or the emotion voice. Specifically, the emotion decider 15c decides that an emotion corresponding to the largest total emotion score among total emotion scores pertaining to each emotion is the user's emotion. That is, the larger a total emotion score is, the more likely an emotion pertaining to the total emotion is decided as the user's emotion. As described above, when an emotion phoneme sequence is included in a voice, the total emotion score is acquired by adding an adjustment score. Furthermore, the higher relevance between corresponding emotion and the emotion phoneme sequence is, the larger a value set as the adjustment score is. Hence, when an emotion phoneme sequence is included in a voice, an emotion having higher relevance to the emotion phoneme sequence is more likely to be decided as an emotion the user felt when uttering the voice. That is, the emotion decider 15c can improve accuracy of emotion recognition by executing emotion recognition taking into consideration the relevance between an emotion phoneme sequence and the user's emotion. In particular, in the case where there is no significant difference between voice emotion scores and facial emotion scores pertaining to each emotion and there is a risk that deciding the user's emotion only on the basis of the voice emotion scores and facial emotion scores would result in erroneous recognition of the user's emotion, the emotion decider 15c can improve accuracy of emotion recognition by taking into consideration the relevance between an emotion phoneme sequence and the user's emotion which is represented by an adjustment score.

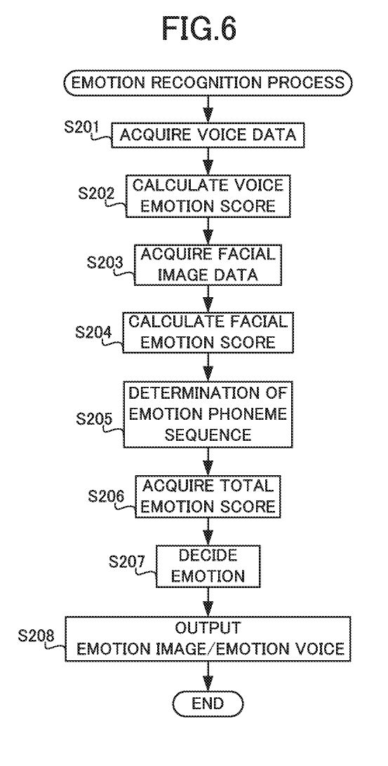

Hereinafter, a learning process and an emotion recognition process executed by the information processing apparatus 1 comprising the aforementioned physical and functional components are described with reference to the flowcharts in FIGS. 5 and 6.

First, the learning process executed by the information processing apparatus 1 in the learning mode is described with reference to the flowchart in FIG. 5. The information processing apparatus 1 acquires a plurality of pieces of voice data 102b, a plurality of pieces of facial image data 102c, a first parameter 102d, and a second parameter from an external apparatus via the external interface 105 and stores these pieces of data in the ROM 102 in advance. With this state established, when the user, by operating the inputter 103, selects the learning mode as the operation mode for the information processing apparatus 1 and then designates any one of the plurality of pieces of the voice data 102b, the CPU 100 starts the learning process shown in the flowchart in FIG. 5.

First, the voice inputter 10 acquires the voice data 102b designated by the user from the ROM 102 (step S101), and supplies the voice data 102b to the voice emotion score calculator 11 and to the learner 14. The voice emotion score calculator 11 calculates a voice emotion score in accordance with the voice data 102b acquired in the processing in step S101 (step S102), and supplies the calculated voice emotion score to the learner 14. The image inputter 12 acquires from the ROM 102 the facial image data 102c stored in association with the voice data 102 acquired in the processing in step S101 (step S103), and supplies the acquired facial image data 102c to the facial emotion score calculator 13. The facial emotion score calculator 13 calculates a facial emotion score in accordance with the facial image data 102c acquired in the processing in step S103 (step S104), and supplies the calculated facial emotion score to the learner 14.

Next, the phoneme sequence converter 14a converts the voice data 102b acquired in step S101 into phoneme sequences (step S105), and supplies the phoneme sequences to the candidate phoneme sequence extractor 14b. The candidate phoneme sequence extractor 14b extracts, from phoneme sequences generated in the processing in step S105, a phoneme sequence that satisfies the aforementioned extraction condition as a candidate phoneme sequence(step S106), and supplies the extracted candidate phoneme sequence to the frequency generator 14c. With respect to each candidate phoneme sequence extracted in the processing in step S106, the frequency generator 14c determines, for each of the aforementioned three types of emotions, whether a possibility that an emotion the user felt when uttering a voice corresponding to the candidate phoneme sequence is the emotion is significantly high, in accordance with the voice emotion score and facial emotion score corresponding to the voice respectively calculated in the processing in steps S102 and S104, and generates frequency information representing a result of the determination (step S107). The frequency generator 14c supplies the generated frequency information to the frequency recorder 14d. The frequency recorder 14d updates the frequency data 102f stored in the ROM 102 in accordance with the frequency information generated in the processing in step S107 (step S108). The emotion phoneme sequence determiner 14e acquires the relevance of each candidate phoneme sequence to each emotion in accordance with the frequency data 102f updated in the processing in step S108, and determines whether each candidate phoneme sequence is an emotion phoneme sequence by evaluating the relevance (step S109). The emotion phoneme sequence determiner 14e supplies a result of the determination to the emotion phoneme sequence recorder 14g, while supplying the acquired relevance to the adjustment score generator 14f. The adjustment score generator 14f generates an adjustment score corresponding to the relevance acquired in the processing in step S109 (step S110). The emotion phoneme sequence recorder 14g updates the emotion phoneme sequence data 102g in accordance with the result of the determination in the processing in step S109 and with the adjustment score generated in the processing in step S110 (step S111), and ends the learning process.

Next, the emotion recognition process executed in the emotion recognition mode by the information processing apparatus 1 is described with reference to the flowchart in FIG. 6. Before executing the emotion recognition process, the information processing apparatus 1 learns an emotion phoneme sequence by executing the aforementioned learning process and stores the emotion phoneme sequence data 102g in the ROM 102 which includes each emotion phoneme sequence and adjustment scores in association with each other. Furthermore, the information processing apparatus 1 acquires a plurality of pieces of voice data 102b, a plurality of pieces of facial image data 102c, a first parameter 102d, and a second parameter from an external apparatus via the external interface 105 and stores these pieces of data in the ROM 102 in advance. With this state established, when the user, by operating the inputter 103, selects the emotion recognition mode as the operation mode for the information processing apparatus 1 and then designates any one of the pieces of the voice data 102b, the CPU 100 starts the emotion recognition process shown in the flowchart in FIG. 6.

First, the voice inputter 10 acquires the designated voice data 102b from the ROM 102 (step S201), and supplies the voice data to the voice emotion score calculator 11. The voice emotion score calculator 11 calculates voice emotion scores in accordance with the voice data 102b acquired in the processing in step S201 (step S202), and supplies the voice emotion scores to the processing unit 15. The image inputter 12 acquires from the ROM 102 the facial image data 102c stored therein in association with the voice data 102b acquired in the processing in step S201 (step S203), and supplies the image data to the facial emotion score calculator 13. The facial emotion score calculator 13 calculates facial emotion scores in accordance with the facial image data 102c acquired in the processing in step S203 (step S204), and supplies the facial emotion scores to the processing unit 15.

Next, the emotion phoneme sequence detector 15a determines whether any emotion phoneme sequence is included in the voice represented by the voice data 102b acquired in the processing in step S201 (step S205). The emotion phoneme sequence detector 15a supplies a result of the determination to the emotion score adjuster 15b. In addition, if the determination is made that an emotion phoneme sequence is included in the voice, the emotion phoneme sequence detector 15a acquires an adjustment score that is included in the emotion phoneme sequence data 102g in association with the emotion phoneme sequence, and supplies the adjustment score to the emotion score adjuster 15b. The emotion score adjuster 15b acquires a total emotion score pertaining to each emotion in accordance with the result of the determination in the processing in step S205 (step S206), and supplies the total emotion score to the emotion decider 15c. Specifically, if the determination is made in the processing in step S205 that an emotion phoneme sequence is included in the voice, the emotion score adjuster 15b acquires a total emotion score pertaining to each emotion by summing up, for each emotion, the voice emotion score calculated in the processing in step S202, the facial emotion score calculated in the processing in step S204, and the adjustment score corresponding to the emotion phoneme sequence supplied by the emotion phoneme sequence detector 15a. Furthermore, if the determination is made in step S205 that no emotion phoneme sequence is included in the voice, the emotion score adjuster 15b acquires a total emotion score pertaining to each emotion by summing up, for each emotion, the voice emotion score calculated in the processing in step S202 and the facial emotion score calculated in the processing in step S204. Next, the emotion decider 15c decides that the emotion corresponding to the largest total emotion score among the total emotion scores pertaining to each emotion acquired in the processing in step S206 is the emotion the user felt when uttering a voice represented by the voice data 102b that is acquired in the processing in step S201 (step S207). The emotion decider 15c generates an emotion image or an emotion voice representing the emotion decided in the processing in step S207, causes the outputter 104 to output the emotion image or emotion voice (step S208), and ends the emotion recognition process.

As described above, in the learning mode, the information processing apparatus 1 learns a phoneme sequence having high relevance to the user's emotion as an emotion phoneme sequence, while in the emotion recognition mode, the information processing apparatus 1 makes an emotion having higher relevance to an emotion phoneme sequence more likely to be decided as the emotion the user felt when uttering a voice that includes the emotion phoneme sequence. Consequently, the information processing apparatus 1 can reduce the possibility of erroneous recognition of the user's emotion and improve accuracy of emotion recognition. In other words, the information processing apparatus 1 can suppress execution of a process that does not conform to an emotion of a user by taking into consideration a result of learning in the learning mode. That is, the information processing apparatus 1 can recognize, by taking into consideration the relevance between an emotion phoneme sequence and an emotion which is an information being unique to a user, the user's emotion more accurately than an emotion recognition using only general-purpose data. Furthermore, the information processing apparatus 1 can enhance personal adaptation and progressively improve the accuracy of emotion recognition by learning the relevance between an emotion phoneme sequence and an emotion type being information unique to a user by executing the aforementioned learning process.

### Embodiment 2

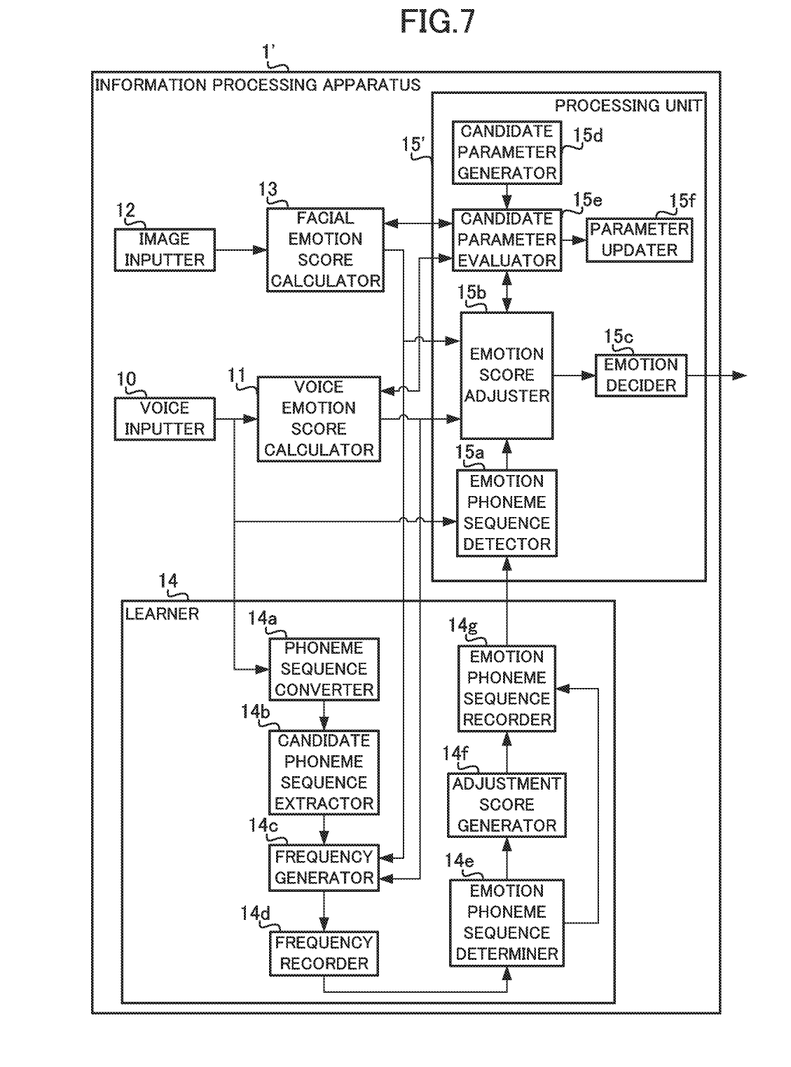

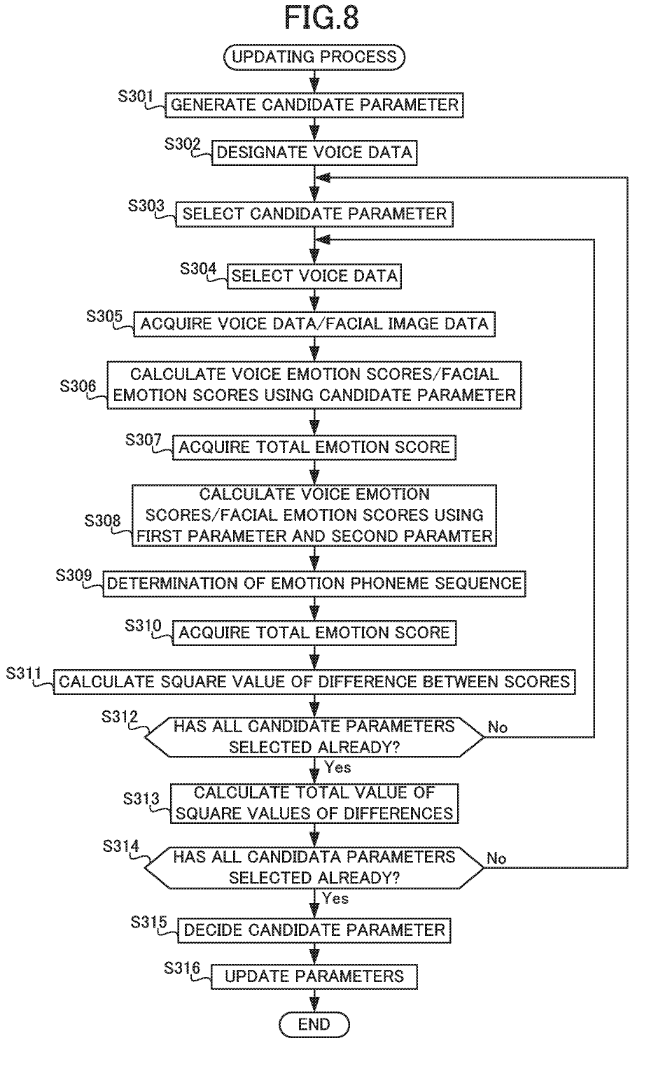

According to Embodiment 1 described above, in the emotion recognition mode, the information processing apparatus 1 recognizes the user's emotion in accordance with the result of learning in the learning mode, and outputs an emotion image and/or an emotion voice representing the result of the recognition. However, this is a mere example, and the information processing apparatus 1 can execute any process in accordance with the result of learning in the learning mode. Hereinafter, referring to FIGS. 7 and 8, an information processing apparatus lis described that is further provided with an updating mode in addition to the aforementioned learning mode and emotion recognition mode as an operation mode and updates, by operating in accordance with the updating mode, the first parameter 102d and the second parameter 102e used for calculating voice emotion scores and facial emotion scores in accordance with the result of learning in the learning mode.

While the information processing apparatus 1′ has a configuration generally similar to a configuration of the information processing apparatus 1, a configuration of the processing unit 15′ is partially different. Hereinafter, the configuration of the information processing apparatus 1′ is described, focusing on differences from the configuration of the information processing apparatus 1.

As illustrated in FIG. 7, the information processing apparatus 1′ comprises, as functions of the CPU 100, a candidate parameter generator 15d, a candidate parameter evaluator 15e, and a parameter updater 15f. The CPU 100 functions as each of these components by controlling the information processing apparatus 1′ by executing the control program 102a stored in the ROM 102. The candidate parameter generator 15d generates a predetermined number of candidate parameters, which are candidates for a new first parameter 102d and a new second parameter 102e, and supplies the generated candidate parameters to the candidate parameter evaluator 15e. The candidate parameter evaluator 15e evaluates each candidate parameter in accordance with the emotion phoneme sequence data 102g stored in the ROM 102, and supplies a result of the evaluation to the parameter updater 15f. Details of the evaluation will be described below. The parameter updater 15f designates a candidate parameter from the candidate parameters in accordance with the result of evaluation by the candidate parameter evaluator 15e, and updates the first parameter 102d and the second parameter 102e by replacing the first parameter 102d and the second parameter 102e currently stored in the ROM 102 with the designated candidate parameter.

Hereinafter, an updating process executed by the information processing apparatus 1′ is described, referring to the flowchart in FIG. 8. Before executing the updating process, the information processing apparatus 1′ learns emotion phoneme sequences by executing the learning process described in Embodiment 1 above, and stores the emotion phoneme sequence data 102g that includes emotion phoneme sequences and adjustment scores in association with each other in the ROM 102. Furthermore, the information processing apparatus 1′ acquires a plurality of pieces of voice data 102b, a plurality of pieces of facial image data 102c, a first parameter 102d, and a second parameter from an external apparatus via the external interface 105 and stores these pieces of data in the ROM 102 in advance. With this state established, when the user, by operating the inputter 103, selects the updating mode as the operation mode for the information processing apparatus 1′, the CPU 100 starts the updating process shown in the flowchart in FIG. 8.

First, the candidate parameter generator 15d generates a predetermined number of candidate parameters (step S301). The candidate parameter evaluator 15e designates a predetermined number of pieces of voice data 102b from the plurality of pieces of voice data 102b stored in the ROM 102 (step S302). The candidate parameter evaluator 15e selects, as a target of evaluation, one of the candidate parameters generated in the processing in step S301 (step S303). The candidate parameter evaluator 15e selects one of the pieces of voice data 102b designated in the processing in step S302 (step S304).

The candidate parameter evaluator 15e acquires the voice data 102b selected in step 5304 and the facial image data 102c that is stored in the ROM 102 in association with the voice data (step S305). The candidate parameter evaluator 15e causes the voice emotion score calculator 11 and the facial emotion score calculator 13 to calculate voice emotion scores and facial emotion scores respectively corresponding to the voice data 102b and the facial image data 102c acquired in the processing in step S305 in accordance with the candidate parameter selected in the processing in step S303 (step S306). The candidate parameter evaluator 15e acquires a total emotion score by summing up the voice emotion score and the facial emotion score calculated in the processing in step S306 for each emotion (step S307).

Next, the candidate parameter evaluator 15e causes the voice emotion score calculator 11 and the facial emotion score calculator 13 to calculate voice emotion scores and facial emotion scores respectively corresponding to the voice data 102b and the facial image data 102c acquired in the processing in step S305 in accordance with the first parameter 102d and the second parameter 102e currently stored in the ROM 102 (step S308). The emotion phoneme sequence detector 15a determines whether any emotion phoneme sequence is included in the voice represented by the voice data 102b acquired in the processing in step S305 (step S309). The emotion phoneme sequence detector 15a supplies a result of the determination to the emotion score adjuster 15b. In addition, if the determination is made that an emotion phoneme sequence is included in the voice, the emotion phoneme sequence detector 15a acquires adjustment scores included in the emotion phoneme sequence data 102g in association with the emotional phoneme sequence, and supplies the adjustment scores to the emotion score adjuster 15b. The emotion score adjuster 15b acquires a total emotion score in accordance with the result of the determination in the processing in step S309 and the supplied adjustment scores (step S310).

The candidate parameter evaluator 15e calculates a square value of a difference between the total emotion score acquired in the processing in step S307 and the total emotion score acquired in the processing in step S310 (step S311). The calculated square value of the difference represents a matching degree between the candidate parameter selected in the processing in step S303 and the result of the learning in the learning mode being evaluated in accordance with the voice data 102b selected in the processing in step S304. The smaller the square value of the difference is, the higher the matching degree between the candidate parameter and the result of the learning is. The candidate parameter evaluator 15e determines whether all the pieces of voice data 102b designated in the processing in step S302 have been selected already (step S312). When the candidate parameter evaluator 15e determines that at least one of the pieces of voice data 102b designated in the processing in step S302 has not been selected yet (No in step S312), the processing returns to step S304 and then any one of pieces of voice data 102b that has not been selected yet is selected.

When the determination is made that all the pieces of voice data 102b designated in the processing in step S302 have been selected already (Yes in step S312), the candidate parameter evaluator 15e calculates a total value of square values of the difference corresponding to each piece of voice data 102b calculated in the processing in step S311 (step S313). The calculated total value of the square values of the difference represents a matching degree between the candidate parameter that is selected in the processing in step S303 and the result of the learning in the learning mode being evaluated in accordance with all the pieces of voice data 102b designated in the processing in step S302. The smaller the total value of the square values of the differences is, the higher the matching degree between the candidate parameter and the result of the learning is. The candidate parameter evaluator 15e determines whether all the plurality of candidate parameters generated in the processing in step S301 have been selected already (step S314). When the candidate parameter evaluator 15e determines that at least one of the candidate parameters generated in the processing in step S301 has not been selected yet (No in step S314), the processing returns to step S303 and then any one of candidate parameters that has not been selected yet is selected. The CPU 100 evaluates the matching degree between every candidate parameter generated in step S301 and the result of the learning in the learning mode in accordance with the plurality of pieces of voice data 102b designated in step S302, by repeating the processing of steps S303 to S314 until the decision of Yes is made in the processing in step S314.

When the determination is made that all the candidate parameters generated in the processing in step S301 have been selected already (Yes in step S314), the parameter updater 15f decides, from among the candidate parameters, the candidate parameter corresponding to the smallest total value of square values of differences, as calculated in the processing in step S313, as the new first parameter 102d and the new second parameter 102e (step S315). In other words, the parameter updater 15f decides, from among the candidate parameters, the candidate parameter having the highest matching degree between the result of the learning in the learning mode as the new first parameter 102d and the new second parameters 102e in the processing in step S315. The parameter updater 15f updates the first parameter 102d and the second parameter 102e by replacing the first parameter 102d and the second parameter 102e currently stored in the ROM 102 with the candidate parameter decided in the processing in step S315 (step S316), and ends the updating process.

In the emotion recognition mode, the information processing apparatus 1′ executes the aforementioned emotion recognition process shown in the flowchart in FIG. 6, by calculating voice emotion scores and facial emotion scores using the first parameter 102d and the second parameter 102e updated in the updating mode. Consequently, accuracy of emotion recognition is improved.

As described above, the information processing apparatus 1′ updates the first parameter 102d and the second parameter 102e in the updating mode so that they match the result of the learning in the learning mode, and then executes emotion recognition in the emotion recognition mode using the updated first parameter 102d and the updated second parameter 102e. Consequently, the information processing apparatus 1′ can improve accuracy of the emotion recognition. By updating parameters themselves that are used for calculating the voice emotion scores and the facial emotion scores in accordance with the result of the learning, accuracy of the emotion recognition can be improved even when a voice does not include any emotion phoneme sequence.

While embodiments of the present disclosure have been described above, these embodiments are mere examples and the scope of present disclosure is not limited thereto. That is, the present disclosure allows for various applications and every possible embodiment is included in the scope of the present disclosure.

For example, in Embodiments 1 and 2 described above, the information processing apparatus 1, 1′ is described to execute learning of emotion phoneme sequences, recognition of the user's emotion, and updating of parameters in accordance with voice emotion scores and facial emotion scores. However, this is a mere example. The information processing apparatus 1, 1′ may execute the aforementioned processes by using any emotion score that indicates a level of possibility that an emotion the user felt when uttering a voice corresponding to a phoneme sequence is a certain emotion. For example, the information processing apparatus 1, 1′ may execute the aforementioned processes using only the voice emotion scores, or using voice emotion scores in combination with any emotion scores other than the facial emotion scores.

In Embodiments 1 and 2 described above, the frequency generator 14c is described to acquire a total emotion score pertaining to each emotion by summing up the voice emotion score and the facial emotion score for each emotion and determine whether the voice emotion score and the facial emotion score satisfy the detection condition by determining whether the total emotion score is equal to or greater than the detection threshold. However, this is a mere example, and any condition may be set as the detection condition. For example, the frequency generator 14c may acquire a total emotion score for each emotion by summing up the weighted voice emotion score and the weighted facial emotion score for each emotion, the weight being predetermined, and may determine whether the voice emotion score and the facial emotion score satisfy a detection condition by determining whether the total emotion score is equal to or greater than a detection threshold. In this case, the weight may be set using any method such as an experiment and the like.

In Embodiments 1 and 2 described above, the emotion phoneme sequence determiner 14e is described to determine that, among candidate phoneme sequences, a candidate phoneme sequence is an emotion phoneme sequence, if the relevance between the candidate phoneme sequence and any one of the aforementioned three types of emotions is significantly high and the emotion frequency ratio is equal to or greater than the learning threshold. However, this is a mere example. The emotion phoneme sequence determiner 14e may determine whether a candidate phoneme sequence is an emotion phoneme sequence using any method in accordance with the frequency data 102f. For example, the emotion phoneme sequence determiner 14e may determine that a candidate phoneme sequence having significantly high relevance to one of the three types of emotion is an emotion phoneme sequence, irrespective of the emotion frequency ratio. Alternatively, the emotion phoneme sequence determiner 14e may determine that, among candidate phoneme sequences, a candidate phoneme sequence having an emotion frequency ratio of the emotion frequency pertaining to any one of the three types of emotion being equal to or greater than the learning threshold is an emotion phoneme sequence, irrespective of whether the relevance between the candidate phoneme sequence and the emotion type is significantly high or not.

In Embodiment 1 described above, the emotion decider 15c is described to decide the user's emotion in accordance with the adjustment score learned by the learner 14 and with the voice emotion score and facial emotion score supplied by the voice emotion score calculator 11 and the facial emotion score calculator 13. However, this is a mere example. The emotion decider 15c may decide the user's emotion in accordance with the adjustment score only. In this case, in response to the determination that an emotion phoneme sequence is included in a voice represented by the voice data 102b, the emotion phoneme sequence detector 15a acquires the adjustment scores stored in the emotion phoneme sequence data 102g in association with the emotion phoneme sequence, and supplies the adjustment scores to the emotion decider 15c. The emotion decider 15c decides that the emotion corresponding to the largest adjustment score among the acquired adjustment scores is the user's emotion.

In Embodiments 1 and 2 described above, the phoneme sequence converter 14a is described to execute voice recognition on a voice represented by the voice data 102b on a sentence-by-sentence basis to convert the voice into a phoneme sequence with part-of-speech information added. However, this is a mere example. The phoneme sequence converter 14a may execute voice recognition on a word-by-word basis, character-by-character basis, or phoneme-by-phoneme basis. Note that, the phoneme sequence converter 14a can convert not only linguistic sounds but also sounds produced in connection with a physical movement, such as tut-tutting, hiccups, or yawning and the like, into phoneme sequences by executing voice recognition using an appropriate phoneme dictionary or word dictionary. According to this embodiment, the information processing apparatus 1, 1′ can learn a phoneme sequence corresponding to a voice produced in connection with a physical movement, such as tut-tutting, hiccups, or yawning and the like as an emotion phoneme sequence, and can execute processing in accordance with a result of the learning.

In Embodiment 1 described above, the information processing apparatus 1 is described to recognize the user's emotion in accordance with the result of the learning in the learning mode, and outputs an emotion image and an emotion voice representing the result of the recognition. Furthermore, in Embodiment 2 described above, the information processing apparatus 1′ is described to update the parameters used for calculating voice emotion scores and facial emotion scores in accordance with the result of the learning in the learning mode. However, these are mere examples. The information processing apparatus 1, 1′ may execute any process in accordance with the result of the learning in the learning mode. For example, in response to supplying of voice data by an external emotion recognition apparatus, the information processing apparatus 1, 1′ may determine whether any learned emotion phoneme sequence is included in the voice data, acquire an adjustment score corresponding to a result of the determination, and supply the adjustment score to the emotion recognition apparatus. That is, in this case, the information processing apparatus 1, 1′ executes a process of supplying the adjustment score to the external emotion recognition apparatus in accordance with the result of the learning in the learning mode. Note that, in this case, a part of the processes that are described to be executed by the information processing apparatus 1, 1′ in Embodiments 1 and 2 described above may be executed by the external emotion recognition apparatus. For example, calculating of voice emotion and facial emotion scores may be executed by the external emotion recognition apparatus.

In Embodiments 1 and 2 described above, the information processing apparatus 1, 1′ is described to recognize the user's emotion as one of three types of emotions: the positive emotion, the negative emotion, and the neutral emotion. However, this is a mere example. The information processing apparatus 1, 1′ may identify any number of emotions of a user, the number being equal to or greater than two. Furthermore, a user's emotions can be classified by using any method.

In Embodiments 1 and 2 described above, the voice data 102b and the facial image data 102c are described to be generated by an external recording apparatus and an external imaging apparatus respectively. However, this is a mere example. The information processing apparatus 1, 1′ itself may generate the voice data 102b and the facial image data 102c. In this case, the information processing apparatus 1, 1′ may comprise a recording device and an imaging device, and generate the voice data 102b by recording a voice uttered by the user using the recording device, while generating the facial image data 102c by imaging a facial image of the user using the imaging device. In this case, while operating in the emotion recognition mode, the information processing apparatus 1, 1′ may acquire a voice uttered by the user and acquired by the recording device as the voice data 102b, acquire the user's facial image acquired by the imaging device when the user uttered the voice as the facial image data 102c, and execute emotion recognition of the user in real time.

Note that, while it is needless to say that an information processing apparatus that is preconfigured to realize the functions of the present disclosure can be provided as the information processing apparatus according to the present disclosure, an existing information processing apparatus, such as a personal computer (PC), a smart phone, or a tablet terminal and the like, can be caused to function as the information processing apparatus according to the present disclosure by applying a program to the existing information processing apparatus. That is, an existing information processing apparatus can be caused to function as the information processing apparatus according to the present disclosure by applying a program for realizing each functional component of the information processing apparatus of the present disclosure in such a way that the program can be executed by a computer controlling the existing information processing apparatus. Note that, such a program can be applied by using any method. For example, the program may be applied by storing in a non-transitory computer-readable storage medium such as a flexible disk, a compact disc (CD)-ROM, a digital versatile disc (DVD)-ROM, or a memory card and the like. Furthermore, the program may be superimposed on a carrier wave and be applied via a communication network such as the Internet and the like. For example, the program may be posted to a bulletin board system (BBS) on a communication network and be distributed. Then, the information processing apparatus may be configured so that the aforementioned processes can be executed by starting the program and executing the program under control of the operation system (OS) as with other application programs.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. An information processing apparatus comprising:
a processor; and
a storage that stores a program to be executed by the processor,
wherein the processor is caused to execute by the program stored in the storage:
a learning process that learns a phoneme sequence generated from a voice as an emotion phoneme sequence, in accordance with relevance between the phoneme sequence and an emotion of a user; and
an emotion recognition process that executes processing pertaining to emotion recognition in accordance with a result of learning in the learning process.

2. The information processing apparatus according to claim 1,
wherein the processor is further caused to execute:
an emotion score acquiring process that acquires, with respect to a phoneme sequence and for each emotion, an emotion score pertaining to the emotion, the emotion score representing a level of possibility that an emotion a user felt when uttering a voice corresponding to the phoneme sequence is the emotion;
a frequency data acquiring process that acquires frequency data that includes, in association with a phoneme sequence and for each emotion, an emotion frequency pertaining to the emotion, the emotion frequency being a cumulative value of a number of times of determining that the emotion score pertaining to the emotion and is based on a voice corresponding to the phoneme sequence satisfies a detection condition; and
a determining process that determines, by evaluating relevance between a phoneme sequence and an emotion in accordance with the frequency data, whether the phoneme sequence is the emotion phoneme sequence,
wherein in the learning process, the processor learns the emotion phoneme sequence in accordance with a determination in the determining process.

3. The information processing apparatus according to claim 2,
wherein in the determining process, the processor determines that, from among phoneme sequences, a phoneme sequence satisfying at least one of:
a condition that the phoneme sequence has significantly high relevance to an emotion; and
a condition that a ratio of the emotion frequency pertaining to the emotion included in the frequency data in association with the phoneme sequence to a total value of emotion frequencies pertaining to each emotion included in the frequency data in association with the phoneme sequence is equal to or higher than a learning threshold
is an emotion phoneme sequence.

4. The information processing apparatus according to claim 2,
wherein the processor is further caused to execute an adjustment score generating process that generates an adjustment score that corresponds to relevance between the emotion phoneme sequence and an emotion,
wherein in the learning process, the processor learns the adjustment score in association with the emotion phoneme sequence.

5. The information processing apparatus according to claim 4,
wherein in the emotion recognition process, the processor recognizes an emotion of a user in accordance with the adjustment score.

6. The information processing apparatus according to claim 4,
wherein in the emotion recognition process, the processor updates a parameter used for calculating the emotion score, in accordance with the adjustment score.

7. An emotion recognition method for an information processing apparatus, the method comprising:
a learning step that learns a phoneme sequence generated from a voice as an emotion phoneme sequence, in accordance with relevance between the phoneme sequence and an emotion of a user; and
an emotion recognition step that executes processing pertaining to emotion recognition in accordance with a result of learning in the learning step.

8. The emotion recognition method according to claim 7, the method further comprising:
an emotion score acquiring step that acquires, with respect to a phoneme sequence and for each emotion, an emotion score pertaining to the emotion, the emotion score representing a level of possibility that an emotion a user felt when uttering a voice corresponding to the phoneme sequence is the emotion;
a frequency data acquiring step that acquires frequency data that includes, in association with a phoneme sequence and for each emotion, an emotion frequency pertaining to the emotion, the emotion frequency being a cumulative value of a number of times of determining that the emotion score pertaining to the emotion and is based on a voice corresponding to the phoneme sequence satisfies a detection condition; and
a determining step that determines, by evaluating relevance between a phoneme sequence and an emotion in accordance with the frequency data, whether the phoneme sequence is the emotion phoneme sequence,
wherein the learning step learns the emotion phoneme sequence in accordance with a determination in the determining step.

9. The emotion recognition method according to claim 8,
wherein the determining step determines that, from among phoneme sequences, a phoneme sequence satisfying at least one of:
a condition that the phoneme sequence has significantly high relevance to an emotion; and
a condition that a ratio of the emotion frequency pertaining to the emotion included in the frequency data in association with the phoneme sequence to a total value of emotion frequencies pertaining to each emotion included in the frequency data in association with the phoneme sequence is equal to or higher than a learning threshold
is an emotion phoneme sequence.

10. The emotion recognition method according to claim 8,
wherein the method further comprising an adjustment score generating step that generates an adjustment score that corresponds to relevance between the emotion phoneme sequence and an emotion,
wherein the learning step learns the adjustment score in association with the emotion phoneme sequence.

11. The emotion recognition method according to claim 10,
wherein the emotion recognition step recognizes an emotion of a user in accordance with the adjustment score.

12. The emotion recognition method according to claim 10,
wherein the emotion recognition step updates a parameter used for calculating the emotion score, in accordance with the adjustment score.

13. A non-transitory computer-readable recording medium recording a program that causes a computer built in an information processing apparatus to function as:
a learner that learns a phoneme sequence generated from a voice as an emotion phoneme sequence, in accordance with relevance between the phoneme sequence and an emotion of a user; and
an emotion recognizer that executes processing pertaining to emotion recognition in accordance with a result of learning by the learner.

14. The recording medium according to claim 13,
wherein the program further causes the computer to function as:
an emotion score acquirer that acquires, with respect to a phoneme sequence and for each emotion, an emotion score pertaining to the emotion, the emotion score representing a level of possibility that an emotion a user felt when uttering a voice corresponding to the phoneme sequence is the emotion;
a frequency data acquirer that acquires frequency data that includes, in association with a phoneme sequence and for each emotion, an emotion frequency pertaining to the emotion, the emotion frequency being a cumulative value of a number of times of determining that the emotion score pertaining to the emotion and is based on a voice corresponding to the phoneme sequence satisfies a detection condition; and
a determiner that determines, by evaluating relevance between a phoneme sequence and an emotion in accordance with the frequency data, whether the phoneme sequence is the emotion phoneme sequence,
wherein the learner learns the emotion phoneme sequence in accordance with a determination by the determiner.

15. The recording medium according to claim 14,
wherein the determiner determines that, from among phoneme sequences, a phoneme sequence satisfying at least one of:
a condition that the phoneme sequence has significantly high relevance to an emotion; and
a condition that a ratio of the emotion frequency pertaining to the emotion included in the frequency data in association with the phoneme sequence to a total value of emotion frequencies pertaining to each emotion included in the frequency data in association with the phoneme sequence is equal to or higher than a learning threshold
is an emotion phoneme sequence.

16. The recording medium according to claim 14,
wherein the program further causes the computer to function as an adjustment score generator that generates an adjustment score that corresponds to relevance between the emotion phoneme sequence and an emotion,
wherein the learner learns the adjustment score in association with the emotion phoneme sequence.

17. The recording medium according to claim 16,
wherein the emotion recognizer recognizes an emotion of a user in accordance with the adjustment score.

18. The recording medium according to claim 16,
wherein the emotion recognizer updates a parameter used for calculating the emotion score, in accordance with the adjustment score.
